(19) United States
(12) Patent Application Publication
(10) Pub. No.: US 2022/0044642 A1
(43) Pub. Date: Feb. 10, 2022

(54) BACKLIGHT MODULE AND DISPLAY DEVICE HAVING SAME

(71) Applicant: TCL CHINA STAR OPTOELECTRONICS TECHNOLOGY CO., LTD., Shenzhen, Guangdong (CN)

(72) Inventor: Lixuan CHEN, Shenzhen, Guangdong (CN)

(73) Assignee: TCL CHINA STAR OPTOELECTRONICS TECHNOLOGY CO., LTD., Shenzhen, Guangdong (CN)

(21) Appl. No.: 17/052,837

(22) PCT Filed: Sep. 4, 2020
(86) PCT No.: PCT/CN2020/113377

§ 371 Date: Nov. 4, 2020

(30) Foreign Application Priority Data
Aug. 5, 2020 (CN) 202010777236.1

(51) Int. Cl. G09G 3/34

(52) U.S. Cl. CPC G09G 3/342; G09G 2300/0408

(57) ABSTRACT

A backlight module and a display device having same are disclosed. The backlight module includes a light substrate, a plurality of backlight units, and a drive circuit. Among the backlight units driven by each drive unit, in a same row or a same column, at most two of the backlight units are arranged continuously beside each other, and these backlight units are not arranged in a quadrangular pattern. On a same light substrate, connecting wires between all the backlight units are disposed on a same layer.

### FIELD OF INVENTION

The present disclosure relates to display technology, and especially relates to a backlight module and a display device having same.

### BACKGROUND OF INVENTION

Light emitting diodes (LEDs) used as light sources for fine local control of liquid crystal displays (LCD) have gained more and more attention. For example, very highly localized LED backlights may be supported by using amorphous silicon thin film transistors (αSi TFT) as backlight control substrates.

Present LEDs use low power chips, so the number of chips that can be integrated is limited. In addition, because sizes of the low power chips are small, wire loops are excessively long, have difficulty in manufacture, and have a risk of wire breakage when welding wires. Therefore, there are natural flaws in the present LEDs. A defective rate of the present LEDs is about one part per million. When a LED disconnects, disconnection of the LED causes other LEDs that are connected to the disconnected LED to not emit light, causing an obvious dark area to appear in the backlight, and therefore affecting display effects.

In order to solve the problem of the obvious dark area appearing in the backlight, an interval LED arrangement is provided. Specifically, as shown in FIG. 1, present backlight modules have at least one light substrate. Two light substrates are disposed in FIG. 1. Wherein, each of the light substrates comprises a plurality of first backlight units and a plurality of second backlight units.

Specifically, a first drive unit controls a plurality of first backlight units of a first group, and a second drive unit controls a plurality of second backlight units of a second group. To clearly indicate respective positions of the backlight units in FIG. 1, coordinates of a backlight unit 10 in a lower left corner are represented by (1,1). The first drive unit is used for controlling the plurality of backlight units 10 of the first group that has coordinates of (1,1), (1,3), (2,1), and (2,3), respectively; the second drive unit is used for controlling the plurality of backlight units 10 of the second group that has coordinates of (1,2), (1,4), (2,2), and (2,4), respectively, and so on. It can be seen from FIG. 1 that rows or columns where the second backlight units are located are arranged at intervals with rows or columns where the first backlight units are located. When the wire breakage occurs to the first backlight units, the problem of the obvious dark area caused by a light-off of the backlight module can be effectively resolved by the second drive unit controlling the second backlight units. Similarly, when the wire breakage occurs to the second backlight units, the problem of the obvious dark area caused by the light-off the backlight module by the first drive unit controlling the first backlight units. However, because the rows or the columns where the second backlight units are located are arranged at intervals with the rows or the columns where the first backlight units are located, when the plurality of first backlight units are interconnected through a first wire, the plurality of first backlight units need to be interconnected in a cross-wire manner. Refer to cross-wire zone A in FIG. 1. Similarly, when the plurality of second backlight units are interconnected through a second wire, the plurality of second backlight units need to be interconnected in a cross-wire manner. However, the number of metal wires needs to be increased to achieve interconnections between the plurality of first backlight units or interconnections between the plurality of second backlight units for achieving cross-wire connections.

### SUMMARY OF INVENTION

### Technical Problem

A purpose of the present disclosure is to provide a backlight module and a display device having same, in order to solve a technical problem that wire-crossing is required for a same group of blacklights upon solving a problem of an obvious dark area appearing in backlight modules.

### Technical Solution

In order to achieve the aforementioned purpose, the embodiments of the present disclosure provide a backlight module, comprising: at least one light substrate; a plurality of backlight units, distributed on the light substrate; and a drive circuit having a plurality of drive units each used for driving two or more of the backlight units; wherein among the backlight units driven by each of the drive units, in a same row or a same column, at most two of the backlight units are arranged continuously beside each other, and these backlight units are not arranged in a quadrangular pattern; on a same light substrate, connecting wires between all the backlight units are disposed on a same layer.

Further, when the number of the backlight units driven by each of the drive units is two, the two backlight units are either adjacent to each other or not adjacent to each other.

Further, when the number of the backlight units driven by each of the drive units is three, all the three backlight units are not adjacent to one another, or the three backlight units are adjacent to each other, or one of the three backlight units is not adjacent to one of the other two backlight units.

Further, when the number of the backlight units driven by each of the drive units is more than three, a structure formed by the backlight units that are interconnected has a zigzag shape.

Further, there are at most two types of the dive units, first drive units and second drive units, on a same light substrate; all the first drive units drives a same number and arrangement of the backlight units; all the second drive units drives a same number and arrangement of the backlight units; wherein there are a plurality of the first drive units; and there are at most two second drive units.

Further, when an array of the backlight units driven by the first drive units extends in a direction of the row, the backlight units of each of the light substrate are arranged into an odd number of columns, and the backlight units driven by the second drive units are disposed in a first row or a last row of each light substrate.

Further, when the array of the backlight units driven by the first drive units extends in a direction of the column, the backlight units of each of the light substrate are arranged into an odd number of rows, and the backlight units driven by the second drive units are disposed in a first column or a last column of each light substrate.

Further, when the array of the backlight units driven by the first drive units extends in the direction of the row, the backlight units of each of the light substrate are arranged into an even number of columns, and the backlight units driven by the second drive units are disposed in the first row and the last row of each light substrate.

Further, when the array of the backlight units driven by the first drive units extends in the direction of the column, the backlight units of each of the light substrate are arranged into an even number of rows, and the backlight units driven by the second drive units are disposed in the first column and the last column of each light substrate.

Further, the drive units include third drive units, each of the third drive units drives two backlight units, wherein the two backlight units driven by a same third drive unit are disposed on different light substrates and are disposed in a same row or a same column, and wherein the backlight units driven by the third drive units and the backlight units driven by the second drive units are disposed on opposite sides of the light substrate.

Further, each of the drive units comprises: a switch tube, wherein a source electrode of the switch tube is connected to a first node; a drive tube, wherein a gate electrode of the drive tube is connected to the first node; and a storage capacitor, wherein one end of the capacitor is connected with a negative voltage, and the other end of the capacitor is connected to the first node.

In order to achieve the aforementioned purpose, the embodiments of the present disclosure also provide a display device comprising the backlight module described hereinabove. Wherein the backlight module comprises: at least one light substrate; a plurality of backlight units, distributed on the light substrate; and a drive circuit having a plurality of drive units each used for driving two or more of the backlight units; wherein among the backlight units driven by each of the drive units, in a same row or a same column, at most two of the backlight units are arranged continuously beside each other, and these backlight units are not arranged in a quadrangular pattern; on a same light substrate, connecting wires between all the backlight units are disposed on a same layer.

Further, when the number of the backlight units driven by each of the drive units is two, the two backlight units are either adjacent to each other or not adjacent to each other.

Further, when the number of the backlight units driven by each of the drive units is three, all the three backlight units are not adjacent to one another, or the three backlight units are adjacent to each other, or one of the three backlight units is not adjacent to one of the other two backlight units.

Further, when the number of the backlight units driven by each of the drive units is more than three, a structure formed by the backlight units that are interconnected has a zigzag shape.

Further, there are at most two types of the dive units, first drive units and second drive units, on a same light substrate; all the first drive units drives a same number and arrangement of the backlight units; all the second drive units drives a same number and arrangement of the backlight units; wherein there are a plurality of the first drive units; and there are at most two second drive units.

Further, when an array of the backlight units driven by the first drive units extends in a direction of the row, the backlight units of each of the light substrate are arranged into an odd number of columns, and the backlight units driven by the second drive units are disposed in a first row or a last row of each light substrate; and

when the array of the backlight units driven by the first drive units extends in a direction of the column, the backlight units of each of the light substrate are arranged into an odd number of rows, and the backlight units driven by the second drive units are disposed in a first column or a last column of each light substrate.

Further, when the array of the backlight units driven by the first drive units extends in the direction of the row, the backlight units of each of the light substrate are arranged into an even number of columns, and the backlight units driven by the second drive units are disposed in the first row and the last row of each light substrate; and

when the array of the backlight units driven by the first drive units extends in the direction of the column, the backlight units of each of the light substrate are arranged into an even number of rows, and the backlight units driven by the second drive units are disposed in the first column and the last column of each light substrate.

Further, the drive units include third drive units, each of the third drive units drives two backlight units, wherein the two backlight units driven by a same third drive unit are disposed on different light substrates and are disposed in a same row or a same column, and wherein the backlight units driven by the third drive units and the backlight units driven by the second drive units are disposed on opposite sides of the light substrate.

Further, each of the drive units comprises: a switch tube, wherein a source electrode of the switch tube is connected to a first node; a drive tube, wherein a gate electrode of the drive tube is connected to the first node; and a storage capacitor, wherein one end of the capacitor is connected with a negative voltage, and the other end of the capacitor is connected to the first node.

### Beneficial Effects

The technical effect of the present invention is that the present invention provides the backlight module and the display device having same. Wherein a cross-wire phenomena do not occur when the backlight units are interconnected through the connecting wires, and wherein the connecting wires between all of the backlight units are disposed on a same layer. Compared to the prior arts, the plurality of backlight units of the present disclosure do not need to be connected by cross-wire connections, and there is no need of additionally adding a metal layer to achieve the cross-wire connections.

In addition, most of the backlight units of the present disclosure are interconnected by the connecting wires to form the structure having the zigzag shape. The backlight units driven by each of the drive units are combined into a group. When one of the groups of the backlight units goes off, the backlight units adjacent to that group illuminate a light-off area which may thus be formed, thereby preventing the light-off area from causing a dark area, and ensuring normal display of the display device.

### DESCRIPTION OF DRAWINGS

The technical aspects of the present invention and other advantageous effects will be apparent through the following detailed description of specific embodiments of the disclosure taken in conjunction with the accompanying drawings.

FIG. 1 is a structural schematic view of backlight units of a backlight module of the prior art;

FIG. 2 is a first arrangement diagram of three backlight units according to some embodiments of the present disclosure;

FIG. 3 is a schematic view of a circuit of a backlight module according to some embodiments of the present disclosure;

FIG. 4 is a first arrangement diagram of two backlight units according to embodiment 1 of the present disclosure;

FIG. 5 is a second arrangement diagram of two backlight units according to embodiment 1 of the present disclosure;

FIG. 6 is a second arrangement diagram of three backlight units according to embodiment 2 of the present disclosure;

FIG. 7 is a third arrangement diagram of three backlight units according to embodiment 2 of the present disclosure;

FIG. 8 is a first arrangement diagram of more than three backlight units according to embodiment 3 of the present disclosure;

FIG. 9 is a second arrangement diagram of more than three backlight units according to embodiment 3 of the present disclosure;

FIG. 10 is a third arrangement diagram of more than three backlight units according to embodiment 4 of the present disclosure;

FIG. 11 is a fourth arrangement diagram of more than three backlight units according to embodiment 4 of the present disclosure; and

FIG. 12 is a fifth arrangement diagram of more than three backlight units according to other embodiments of the present disclosure.

Reference numbers of elements presented in the drawings are as follows:

| | |
|---|---|
| 10 backlight unit; | 20 drive unit; |
| 30 first node; | |
| 100 light substrate; | 200 drive circuit; |
| 101 connecting wire; | |
| 201 first drive unit; | 202 second drive unit; |
| 203 third drive unit; | |
| 1011 first connecting wire; | 1012 second connecting wire; and |
| 1013 third connecting wire. | |

### DETAILED DESCRIPTION OF PREFERRED EMBODIMENTS

The technical solutions in the embodiments of the present disclosure are clearly and completely described as follows with reference to the accompanying drawings in the embodiments. It is apparent that the described embodiments are only a part of the embodiments of the present disclosure, and not all of the embodiments. All other embodiments obtained by a person skilled in the art based on the embodiments of the present disclosure without inventive efforts are within the scope of the present disclosure.

The following description provides the number of different embodiments or examples for implementing the different structures of the present disclosure. In order to simplify the present disclosure, components and arrangements of specific examples are described below. Certainly, the examples are merely exemplary and are not intended to limit the present disclosure. In addition, for the sake of simplicity and clarity, the reference numerals and/or the reference letters may repeat in different examples in the present disclosure, which does not indicate the relationship between the various discussed embodiments and/or arrangements. Moreover, the examples of various specific processes and materials are provided in the present disclosure, but a person of ordinary skill in the art will appreciate the application of other processes and/or the use of other materials.

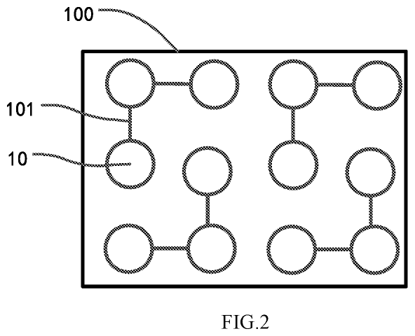

As shown in FIG. 2, the present embodiment provides a backlight module comprising at least one light substrate 100 having a plurality of backlight units 10 arranged on the light substrate 100 in an array.

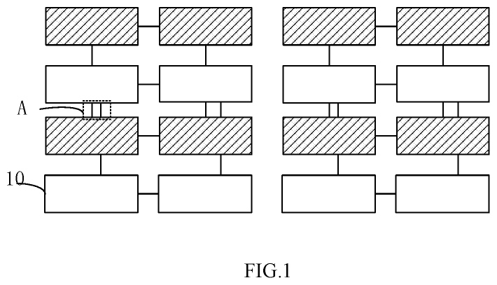

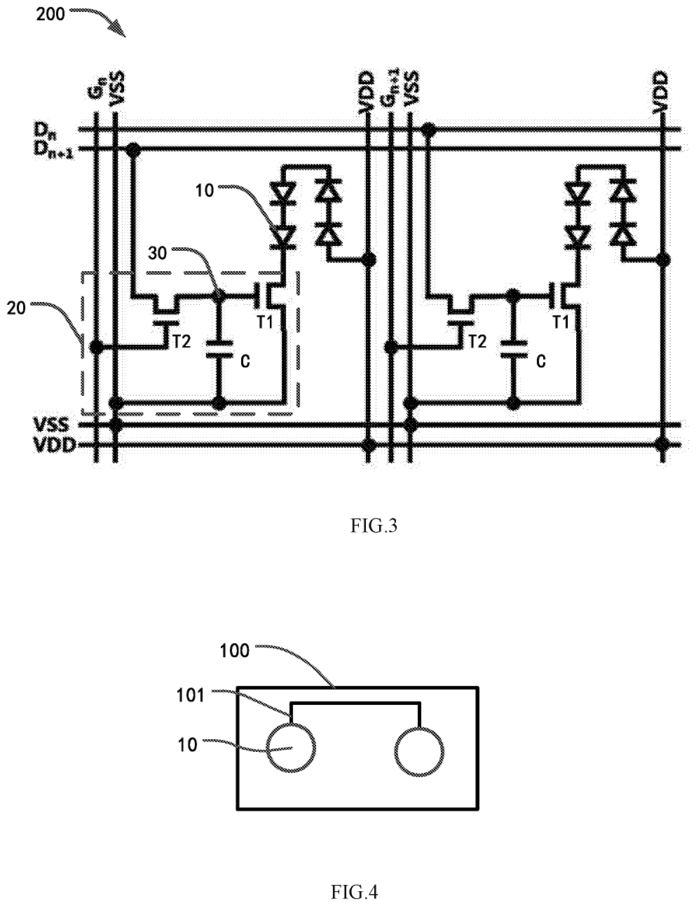

As shown in FIG. 3, which is a schematic view of a circuit of the backlight module according to the present embodiment. Wherein a drive circuit 200 has a plurality of drive units 20 each used for driving two or more of the backlight units 10 connected in series. It should be noted that while each of the drive units 20 in FIG. 1 controls four backlight units 10, the number of the backlight units 10 that one drive units 20 may control is not limited to the case. For example, each of the drive units 20 also may control six backlight units 10 or each of the drive units 20 also may control eight backlight units 10. In other embodiments, other number of the backlight units 10 may be disposed according to the actual need. Certainly, it is most preferred to set the number of the backlight units 10 according to a charging capacity of a capacitor of each drive units 20.

Each of the drive units 20 comprises: a switch tube T2, wherein a source electrode of the switch tube T2 is connected to a first node 30; a drive tube T1, wherein a gate electrode of the drive tube T1 is connected to the first node 30; and a storage capacitor C, wherein one end of the capacitor C is connected with a negative voltage VSS and the other end of the capacitor is connected to the first node 30. Anodes of the backlight units 10 are connected with a positive voltage VDD.

The embodiments of the present disclosure provide a backlight module, wherein among the backlight units 10 driven by each of the drive units 20, in a same row or a same column, at most two of the backlight units 10 are arranged continuously beside each other, and these backlight units 10 are not arranged in a quadrangular pattern. On a same light substrate 100, connecting wires 101 between all the backlight units 10 are disposed on a same layer.

It is to be noted that, in the present embodiment, the backlight units besides each other refers to the relationship between the position of a backlight unit and the backlight units respectively located under, above, on the left, and on the right thereof.

### Embodiment 1

As shown in FIG. 4, when the number of backlight units 10 driven by each drive unit 20 is two, the two backlight units 10 are adjacent to each other, are disposed on a same layer, and are connected through a connecting wire 101, thereby solving a problem of wire-crossing between multiple connecting wires 101 on the light substrate 100.

As shown in FIG. 5, when the number of the backlight units 10 driven by each of the drive units 20 is two, the two backlight units 10 are not adjacent to each other, are disposed on a same layer, and are connected through the connecting wire 101, thereby solving the problem of wire-crossing between multiple connecting wires 101 on the light substrate 100.

The embodiment provides a display device, comprising the backlight module described hereinabove. The display device can be any product or component with display function, such as electronic papers, mobile phones, tablet computers, TVs, monitors, laptops, digital photo frames, or navigators.

The present embodiment provides a backlight module and a display device, wherein the light substrate has the plurality of drive units, and when the number of the backlight units driven by each of the drive units is two, the two backlight units are either adjacent to each other or not adjacent to each other, to resolve the problem of wire-crossing that is likely to arise between multiple connecting wires on the light substrate. Further, when the backlight units driven by one of the drive units on the light substrate go off, the backlight units adjacent to that group illuminate a light-off area which may thus be formed, thereby preventing the light-off area from causing a dark area, and ensuring normal display of the display device.

### Embodiment 2

The present embodiment provides a backlight module and a display device having same, including most of the technical solution of embodiment 1. The difference is that when the number of backlight units driven by each drive unit is three, all the three backlight units are not adjacent to one another, or the three backlight units are adjacent to each other, or one of the three backlight units is not adjacent to one of the other two backlight units.

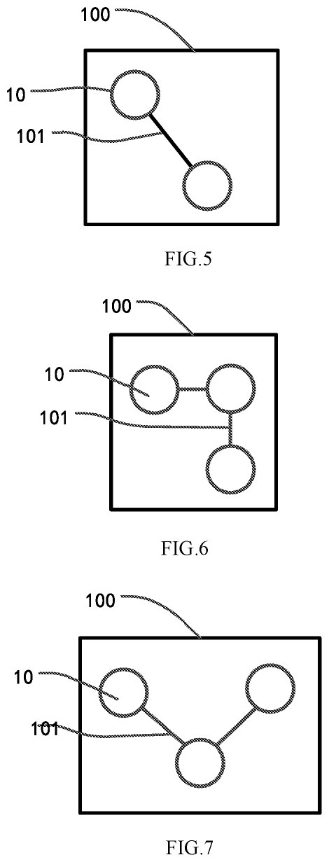

As shown in FIG. 6, when the number of the backlight units driven by each of the drive units is three, the three backlight units are adjacent to each other, thereby solving a problem of wire-crossing between multiple connecting wires 101 on a light substrate 100.

As shown in FIG. 7, when the number of the backlight units driven by each of the drive units is three, the three backlight units are not adjacent to one another, thereby solving the problem of wire-crossing between the multiple connecting wires 101 on the light substrate 100.

In other embodiments, when the number of the backlight units driven by each of the drive units is three, one of the three backlight units is not adjacent to one of the other two backlight units, thereby solving the problem of wire-crossing between the multiple connecting wires 101 on the light substrate 100.

The present embodiment provides the backlight module and the display device having same, wherein there are a plurality of drive units disposed on one light substrate. When the number of the backlight units driven by each of the drive units is three, all the three backlight units are not adjacent to one another, or the three backlight units are adjacent to each other, or one of the three backlight units is not adjacent to one of the other two backlight units, thereby solving the problem of wire-crossing that is likely to arise between the multiple connecting wires on the light substrate. Further, when the backlight units driven by one of the drive unit on the light substrate go off, the backlight units driven by drive unit adjected to that group illuminate a light-off area which may thus be formed, thereby preventing the light-off area from causing a dark area, and ensuring normal display of the display device.

### Embodiment 3

The present embodiment provides a backlight module and a display device having same, including most of the technical solution of embodiment 1. The difference is that when the number of backlight units driven by each drive unit is more than three, a structure formed by the backlight units that are interconnected has a zigzag shape.

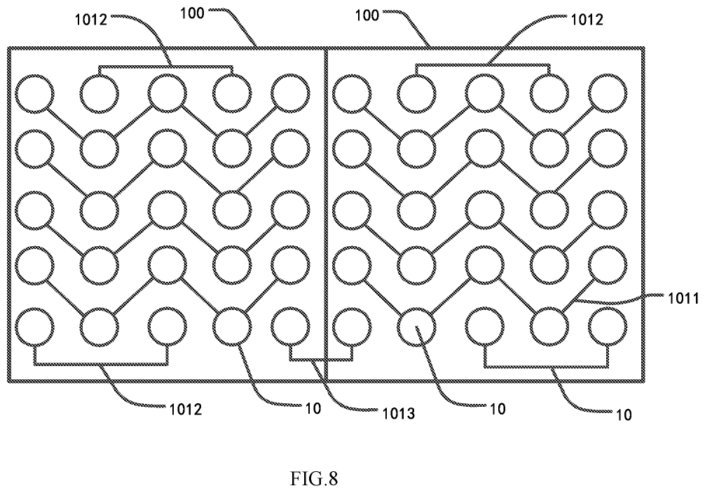

As shown in FIG. 8, there are at most three types of the dive units, first drive units 201, second drive units 202, and third drive units 203 on a same light substrate 100. All the first drive units 201 drives a same number and arrangement of the backlight units. All the second drive units 202 drives a same number and arrangement of the backlight units. Wherein there are a plurality of the first drive units 201 and there are at most two second drive units 202. Wherein the number of the backlight units driven by each of the third drive units 203 is two. Wherein the two backlight units driven by a same third drive unit 203 are disposed on different light substrates 100 and are disposed in a same row or a same column, and wherein the backlight units 10 driven by the third drive units 203 and the backlight units 10 driven by the second drive units 202 are disposed on opposite sides of the light substrate.

As shown in FIG. 8, two light substrates 100 are jointed together. Wherein when an array of the backlight units 10 driven by the first drive units 201 extends in a direction of the row, the backlight units 10 of each of the light substrate 100 are arranged into an odd number of columns, and the backlight units 10 driven by the second drive units 202 are disposed in a first row or a last row of each light substrate 100. Each of the third drive units 203 drives two backlight units 10, wherein the two backlight units 10 driven by a same third drive unit 203 are disposed on different light substrates 100 and are disposed in a same row, and wherein the backlight units 10 driven by the third drive units 203 and the backlight units 10 driven by the second drive units 202 are disposed on opposite sides of the light substrate 100. The backlight units 10 driven by the first drive units 201 are interconnected through a first connecting wire 1011. The backlight units 10 driven by the second drive units 202 are interconnected through a second connecting wire 1012. The backlight units 10 driven by the third drive units 203 are interconnected through a third connecting wire 1013. Wherein the first connecting wire 1011, the second connecting wire 1012, and the third connecting wire 1013 are disposed on a same layer, and no cross-wire connection occurs between adjacent connecting wires.

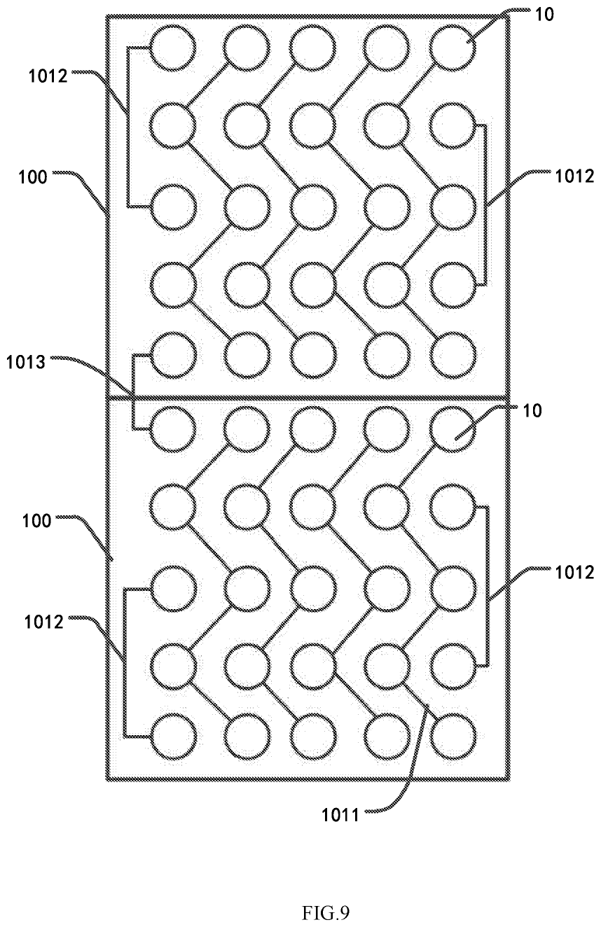

As shown in FIG. 9, two light substrates 100 are jointed together. Wherein when an array of the backlight units 10 driven by the first drive units 201 extends in a direction of the column, the backlight units 10 of each of the light substrate 100 are arranged into an odd number of rows, and the backlight units 10 driven by the second drive units 202 are disposed in a first column or a last column of each light substrate 100. Each of the third drive units 203 drives two backlight units 10, wherein the two backlight units 10 driven by a same third drive unit 203 are disposed on different light substrates 100 and are disposed in a same column, and wherein the backlight units 10 driven by the third drive units 203 and the backlight units 10 driven by the second drive units 202 are disposed on opposite sides of the light substrate 100. The backlight units 10 driven by the first drive units 201 are interconnected through a first connecting wire 1011. The backlight units 10 driven by the second drive units 202 are interconnected through a second connecting wire 1012. The backlight units 10 driven by the third drive units 203 are interconnected through a third connecting wire 1013. Wherein the first connecting wire 1011, the second connecting wire 1012, and the third connecting wire 1013 are disposed on a same layer, and no cross-wire connection occurs between adjacent connecting wires.

The present disclosure provides the backlight module and the display device having same. Wherein the cross-wire phenomena do not occur when the backlight units are interconnected through the connecting wires, and wherein the connecting wires between all of the backlight units are disposed on a same layer. Compared to the prior arts, the plurality of backlight units of the present embodiment do not need to be connected by cross-wire connections, and there is no need of additionally adding metal layer to achieve the cross-wire connections.

Further, in the present embodiment, most of the backlight units on the light substrate are interconnected by the connecting wires to form the structure having the zigzag shape. The backlight units driven by each of the drive units are combined into a group. When one of the groups of the backlight units goes off, the backlight units adjacent to that group illuminate a light-off area which may thus be formed, thereby preventing the light-off area from causing a dark area, and ensuring normal display of the display device.

### Embodiment 4

The present embodiment provides a backlight module and a display device having same, including most of the technical solution of embodiment 1, the difference is that when the number of backlight units driven by each drive units is more than three, a structure formed by the backlight units that are interconnected has a zigzag shape.

As shown in FIG. 8, there are at most two types of the dive units, first drive units 201 and second drive units 202, on a same light substrate 100. All the first drive units 201 drives a same number and arrangement of the backlight units. All the second drive units 202 drives a same number and arrangement of the backlight units. Wherein there are a plurality of the first drive units 201 and there are at most two second drive units 202.

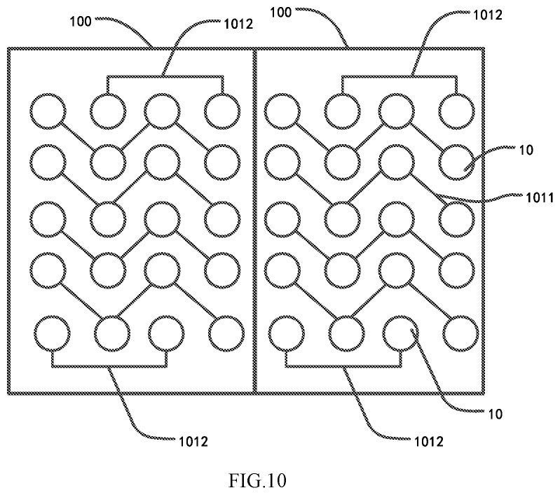

As shown in FIG. 10, when an array of the backlight units 10 driven by the first drive units 201 extends in a direction of a row, the backlight units 10 of each of the light substrate 100 are arranged into an even number of columns, and the backlight units 10 driven by the second drive units 202 are disposed in a first row and a last row of each light substrate 100. The backlight units 10 driven by the first drive units 201 are interconnected through a first connecting wire 1011. The backlight units 10 driven by the second drive units 202 are interconnected through a second connecting wire 1012. Wherein the first connecting wire 1011 and the second connecting wire 1012 are disposed on a same layer, and no cross-wire connection occurs between adjacent connecting wires.

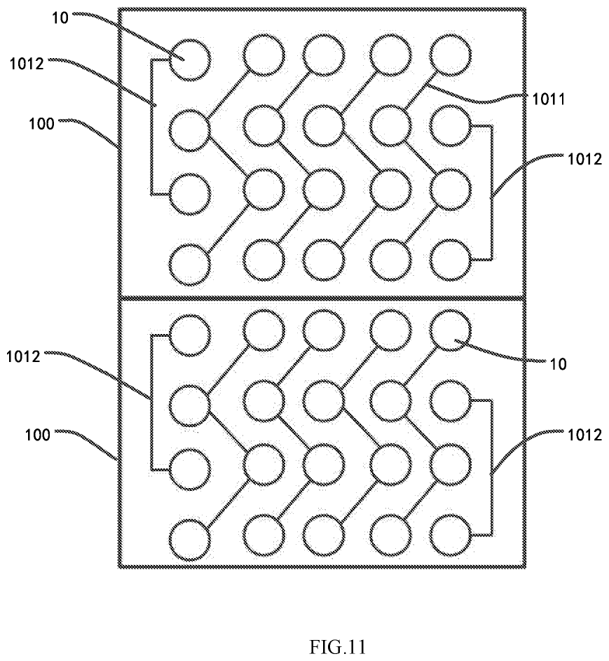

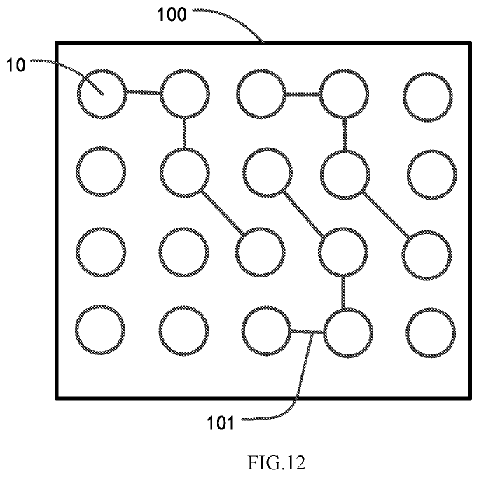

As shown in FIG. 11, When the array of the backlight units 10 driven by the first drive units 201 extends in a direction of the column, the backlight units 10 of each of the light substrate 100 are arranged into an even number of rows, and the backlight units 10 driven by the second drive units 202 are disposed in a first column and a last column of each light substrate 100. The backlight units 10 driven by the first drive units 201 are interconnected through the first connecting wire 1011. The backlight units 10 driven by the second drive units 202 are interconnected through the second connecting wire 1012. Wherein the first connecting wire 1011 and the second connecting wire 1012 are disposed on a same layer, and no cross-wire connection occurs between adjacent connecting wires.

The present disclosure provides the backlight module and the display device having same. Wherein a cross-wire phenomena do not occur when the backlight units are interconnected through the connecting wires, and wherein the connecting wires between all of the backlight units are disposed on a same layer. Compared to the prior arts, the plurality of backlight units of the present disclosure do not need to be connected by cross-wire connections, and there is no need of additionally adding metal layer to achieve the cross-wire connections.

Further, in the present disclosure, most of the backlight units on the light substrate are interconnected through the connecting wires to form the structure having the zigzag shape. The backlight units driven by each of the drive units are combined into a group. When one of the groups of the backlight units goes off, the backlight units adjacent to that group illuminate a light-off area which may thus be formed, thereby preventing the light-off area from causing a dark area, and ensuring normal display of the display device.

As shown in FIG. 12, in other embodiments, on the light substrate 100 of the backlight module, the backlight units 10 driven by each of the drive units may also be connected through the connecting wire 101 to form a polylinear structure of zigzag connections and wherein in a same row or a same column, at most two of the backlight units 10 are arranged continuously beside each other, and these backlight units 10 are not arranged in a quadrangular pattern. Wherein, on a same light substrate 100, connecting wires 101 between all the backlight units 10 are disposed on a same layer.

The above embodiment only describes cases in which the backlight module has one light substrate or has two jointed light substrates. Certainly, in other embodiments that will not be described in detail herein, one backlight module may comprise more than two light substrates. Further, the present disclosure provides the backlight module and the display device having same. Wherein the backlight units are mainly connected by polylinear structures to form a group, and wherein no cross-wire phenomena occur between the connecting wires of the interconnected backlight units, thereby preventing the backlight module from going off, caused by one group of the backlight units, thereby preventing the obvious dark area from appearing on the display device, and thereby ensuring normal display of the display device. Wherein, the connection mean of the zigzag structure can not only drive four backlight units with one drive unit, the connection mean can also be applied to cases of driving three, five, or more backlight units with one drive unit. Those cases will not be described in detail herein.

In the aforementioned embodiments, the description of each embodiment has its own emphasis. For a part that is not detailed in an embodiment, refer to related descriptions in other embodiments.

The backlight module and the display device having same provided in the embodiments of the present disclosure are described in detail above. Specific embodiments are used herein to explain the principles and implementation of the present disclosure. The above embodiments are used to assist in understanding the technical solutions and the core ideas of this disclosure. Those of ordinary skill in the art should understand that the technical solutions described in the foregoing embodiments can be modified, or some of the technical features can be replaced. These modifications and replacements do not substantially deviate the corresponding technical solutions from the scopes of the technical solutions of the embodiments of the present disclosure.

1. A backlight module, comprising:
at least one light substrate;
a plurality of backlight units, distributed on the light substrate; and
a drive circuit having a plurality of drive units each used for driving two or more of the backlight units;
wherein among the backlight units driven by each of the drive units, in a same row or a same column, at most two of the backlight units are arranged continuously beside each other, and these backlight units are not arranged in a quadrangular pattern;
on a same light substrate, connecting wires between all the backlight units are disposed on a same layer.

2. The backlight module as claimed in claim 1, wherein when the number of the backlight units driven by each of the drive units is two, the two backlight units are either adjacent to each other or not adjacent to each other.

3. The backlight module as claimed in claim 1, wherein when the number of the backlight units driven by each of the drive units is three, all the three backlight units are not adjacent to one another, or the three backlight units are adjacent to each other, or one of the three backlight units is not adjacent to one of the other two backlight units.

4. The backlight module as claimed in claim 1, wherein when the number of the backlight units driven by each of the drive units is more than three, a structure formed by the backlight units that are interconnected has a zigzag shape.

5. The backlight module as claimed in claim 1, wherein there are at most two types of the dive units, first drive units and second drive units, on a same light substrate; all the first drive units drives a same number and arrangement of the backlight units; all the second drive units drives a same number and arrangement of the backlight units; wherein there are a plurality of the first drive units; and there are at most two second drive units.

6. The backlight module as claimed in claim 5, wherein when an array of the backlight units driven by the first drive units extends in a direction of the row, the backlight units of each of the light substrate are arranged into an odd number of columns, and the backlight units driven by the second drive units are disposed in a first row or a last row of each light substrate.

7. The backlight module as claimed in claim 5, wherein when the array of the backlight units driven by the first drive units extends in a direction of the column, the backlight units of each of the light substrate are arranged into an odd number of rows, and the backlight units driven by the second drive units are disposed in a first column or a last column of each light substrate.

8. The backlight module as claimed in claim 5, wherein when the array of the backlight units driven by the first drive units extends in the direction of the row, the backlight units of each of the light substrate are arranged into an even number of columns, and the backlight units driven by the second drive units are disposed in the first row and the last row of each light substrate.

9. The backlight module as claimed in claim 5, wherein when the array of the backlight units driven by the first drive units extends in the direction of the column, the backlight units of each of the light substrate are arranged into an even number of rows, and the backlight units driven by the second drive units are disposed in the first column and the last column of each light substrate.

10. The backlight module as claimed in claim 8, wherein the drive units include third drive units, each of the third drive units drives two backlight units, wherein the two backlight units driven by a same third drive unit are disposed on different light substrates and are disposed in a same row or a same column, and wherein the backlight units driven by the third drive units and the backlight units driven by the second drive units are disposed on opposite sides of the light substrate.

11. The backlight module as claimed in claim 1, wherein each of the drive units comprises:
a switch tube, wherein a source electrode of the switch tube is connected to a first node;
a drive tube, wherein a gate electrode of the drive tube is connected to the first node; and
a storage capacitor, wherein one end of the capacitor is connected with a negative voltage, and the other end of the capacitor is connected to the first node.

12. A display device, comprising the backlight module as claimed in claim 1, wherein the backlight module comprises:
at least one light substrate;
a plurality of backlight units, distributed on the light substrate; and
a drive circuit having a plurality of drive units each used for driving two or more of the backlight units;
wherein among the backlight units driven by each of the drive units, in a same row or a same column, at most two of the backlight units are arranged continuously beside each other, and these backlight units are not arranged in a quadrangular pattern;
on a same light substrate, connecting wires between all the backlight units are disposed on a same layer.

13. The display device as claimed in claim 12, wherein when the number of the backlight units driven by each of the drive units is two, the two backlight units are either adjacent to each other or not adjacent to each other.

14. The display device as claimed in claim 12, wherein when the number of the backlight units driven by each of the drive units is three, all the three backlight units are not adjacent to one another, or the three backlight units are adjacent to each other; or one of the three backlight units is not adjacent to one of the other two backlight units.

15. The display device as claimed in claim 12, wherein when the number of the backlight units driven by each of the drive units is more than three, a structure formed by the backlight units that are interconnected has a zigzag shape.

16. The display device as claimed in claim 12, wherein there are at most two types of the dive units, first drive units and second drive units, on a same light substrate; all the first drive units drives a same number and arrangement of the backlight units; all the second drive units drives a same number and arrangement of the backlight units; wherein there are a plurality of the first drive units; and there are at most two second drive units.

17. The display device as claimed in claim 16, wherein when an array of the backlight units driven by the first drive units extends in a direction of the row, the backlight units of each of the light substrate are arranged into an odd number of columns, and the backlight units driven by the second drive units are disposed in a first row or a last row of each light substrate; and
when the array of the backlight units driven by the first drive units extends in a direction of the column, the backlight units of each of the light substrate are arranged into an odd number of rows, and the backlight units driven by the second drive units are disposed in a first column or a last column of each light substrate.

18. The display device as claimed in claim 16, wherein when the array of the backlight units driven by the first drive units extends in the direction of the row, the backlight units of each of the light substrate are arranged into an even number of columns, and the backlight units driven by the second drive units are disposed in the first row and the last row of each light substrate; and
when the array of the backlight units driven by the first drive units extends in the direction of the column, the backlight units of each of the light substrate are arranged into an even number of rows, and the backlight units driven by the second drive units are disposed in the first column and the last column of each light substrate.

19. The display device as claimed in claim 17, wherein the drive units include third drive units, each of the third drive units drives two backlight units, wherein the two backlight units driven by a same third drive unit are disposed on different light substrates and are disposed in a same row or a same column, and wherein the backlight units driven by the third drive units and the backlight units driven by the second drive units are disposed on opposite sides of the light substrate.

20. The display device as claimed in claim 12, wherein each of the drive units comprises:
a switch tube, wherein a source electrode of the switch tube is connected to a first node;
a drive tube, wherein a gate electrode of the drive tube is connected to the first node; and
a storage capacitor, wherein one end of the capacitor is connected with a negative voltage, and the other end of the capacitor is connected to the first node.
